(19) United States
(12) Patent Application Publication
(10) Pub. No.: US 2005/0011663 A1
(43) Pub. Date: Jan. 20, 2005

(54) Frame for cable entry of the like, said frame including a breakable protection

(76) Inventor: Tomas Kreutz, Lyckeby (SE)

Correspondence Address: Steven S. Payne, 8027 ILIFF Drive, Dunn Loring, VA, 22027, US

(21) Appl. No.: 10/895,919

(22) Filed: Jul. 22, 2004

(30) Foreign Application Priority Data
Jan. 22, 2002 (SE) 0200158-4

(51) Int. Cl. H02B 1/30; H02G 13/00; G02C 5/16

(52) U.S. Cl. 174/61

(57) ABSTRACT

A breakable protection for a frame for a cable entry, pipe penetration or the like is disclosed. The frame has a central opening for receiving a compression unit and often one or more sealing units surrounding each cable, pipe or the like. To hinder objects from mistakenly falling through the frame, the breakable protection covers the opening. The breakable protection may be a net or a closed protection. The protection may be a separate part or may be integrated in the frame. The breakable protection is made of a plastic, rubber or metallic material.

### TECHNICAL FIELD

The present invention concerns a frame for a cable entry, pipe penetration or the like.

### PRIOR ART

Different frames of this kind are widely used today. The frames are parts of systems used to seal at a cable entry, pipe penetration etc. In addition to the frame the systems normally comprises further elements or modules to be placed tightly surrounding the cables etc. Systems of this kind are used in many different environments, such as for cabinets, technical shelters, junction boxes and machines. They are used in different industrial environments, such as automotive, telecom, power generation and distribution, as well as marine and offshore.

The seals may have to seal against fluid, gas, fire, rodents, termites, dust, moisture etc. The seal may receive cables for electricity, communication, computers etc. or pipes for different gases or liquids such as water, compressed air, hydraulic fluid and cooking gas.

Normally the frame of the present invention is mounted beforehand and the further parts including the cables, pipes or the like are mounted from one side. As the frames often are open before the cables or the like are mounted, there is always a risk that by mistake parts will fall through the opening of the frame. This is especially the case if the frame is to be mounted in a horizontal position. Furthermore, if the frame is placed at a relatively large height it may be hazardous for any person present in the space under the frame. Parts that may fall through the opening are tools, screws or other fastening means, parts of the cable entry etc. It may also be a problem how one is to retrieve essential parts that has fallen through the opening.

### SUMMARY OF THE INVENTION

One object of the present invention is to hinder that parts mistakenly fall through the opening of the frame.

The above object is met by a frame for a seal for a cable entry, pipe penetration or the like comprising at least one compression unit. The compression unit comprises an elastic body. Furthermore, the frame has an opening for receiving the cable, pipe or the like with or without a further sealing part surrounding the cable, pipe or the like. A breakable protection is arranged in connection to the opening of the frame to close off said opening.

Another object of the present invention is that the protection should be possible to manufacture and fix to the frame in a simple fashion at a relatively low cost. The protection should be strong enough to catch falling objects, but at the same time break when exerted to a force of predetermined strength.

Further objects and advantages of the present invention will be obvious for a person skilled in the art, when reading the detailed description below of preferred embodiments.

### BRIEF DESCRIPTION OF THE DRAWINGS

The invention will be described more closely below by way of an example and with reference to the enclosed drawings. In the drawings:

FIG. 1 is a perspective, exploded view of a frame according to the present invention,

FIG. 2 is a perspective, exploded view of the frame of FIG. 1 taken from the opposite direction,

FIG. 3 is a plan view of a further frame according to the present invention, and

FIG. 4 is a principal drawing of a protection according to a further embodiment of the present invention.

### DETAILED DESCRIPTION OF PREFERRED EMBODIMENTS

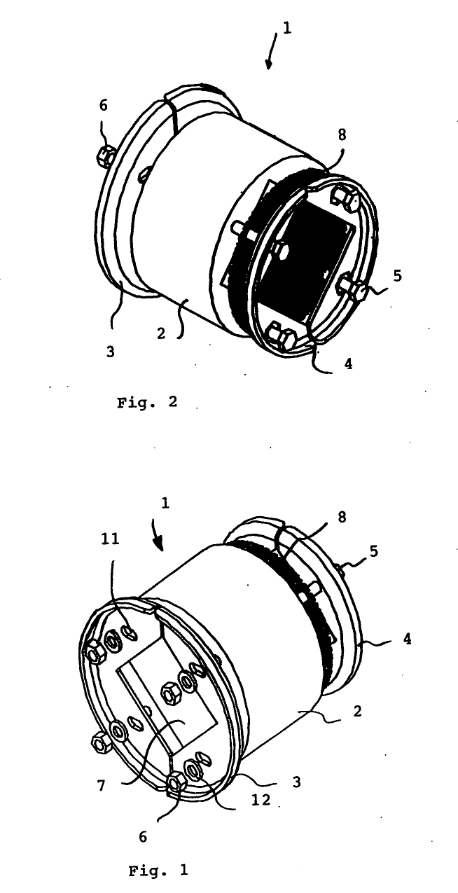

The frame 1 shown in the example of FIGS. 1 and 2 is to be placed in a circular opening of any kind of wall, floor, roof, top or bottom. The frame 1 is formed of an elastic body 2 having a cylindrical form and a central square opening 7. At each end of the elastic body 2, fittings 3, 4 are arranged.

In the shown embodiment there are two front fittings 3 and two rear fittings 4. Each single fitting 3, 4 has the general form of a L, having two straight inner parts being at right angle to each other. The straight inner parts are to match two sides of the opening 7 of the elastic body 2. Furthermore, each fitting 3, 4 has an outer arc going from the area of the outer end of one straight part to the outer end of the other straight part. The ends of the arc are arranged at a distance from the ends of the straight parts. For the front fitting 3 the radius of the arc is somewhat bigger than the outer radius of the elastic body 2 and for the rear fitting 4 the radius of the arc is somewhat smaller than the outer radius of the elastic body 2. After assembly the L-formed fittings 3, 4 at each end are arranged with a small gap between each other and surrounding the central opening 7.

A person skilled in the art realises that the fittings 3, 4 may have other forms and number. In one alternative embodiment there are four fittings at each end, where each fitting has a generally straight extension with a curved side adapted to the form of the elastic body 2.

Normally the fittings 3, 4 extend a short distance inwardly over the central opening 7. In this way any inserts received in the opening will be supported in the axial direction. In the shown embodiment the fittings 3, 4 are bent at the outer periphery. This is often done to increase the flexural rigidity.

The front fittings 3 and the rear fittings 4 are mounted to the elastic body 2 by means of screws 5 received in through openings of the elastic body 2, which screws 5 are to co-operate with nuts 6. Normally a washer 12 is placed between each nut 6 and the fitting 3. In the shown embodiment there are four fastening means in form of screws 5 and nuts 6. A person skilled in the art realises that other numbers of fastening means may be used as well as any suitable fastening means in stead of screw and nut. In the front fittings 3, the openings 11 for receiving the fastening means have the form of slots. Thus, the fittings 3 are possible to move a short distance as soon as the fastening means 5, 6 are loosened. This makes it possible to insert sealing units or the like, without the need to totally remove the fittings 3.

The elastic body 2 of the frame 1 forms a compression unit, which is compressed by means of the fittings 3, 4, screws 5 and nuts 6.

According to the invention a breakable protection is arranged closing off the square opening 7. Normally, the protection is arranged at the back end but a person skilled in the art realises that the protection may be placed in any position along the central opening 7. In the embodiment of FIGS. 1 and 2 the protection is a net 8, which may be made of a plastic, rubber or metallic material. The net 8 is extended to cover the central opening 7 and it is fixed in the frame 1 by means of the fastening means 5, 6. In the shown embodiment the net 8 is fixed to the frame in that the screws 5 are received in openings of the net 8. In other embodiments the net 8 is moulded into the elastic body 2 by being placed in the mould in a position corresponding to the back end of the frame 1 at the manufacture of the elastic body 2.

In further embodiments the protection is closed (see FIG. 4) or has one or more openings in any pattern. The protection may be made of the same material as the elastic body 2 or made of any other suitable plastic, rubber or metallic material. The closed protection 9 may have indications of fracture 10 to facilitate rupture, as indicated in FIG. 4. The protection should be strong enough to hinder that objects mistakenly fall through the opening 7. However, the protection should be fairly easy to break by pressing a tool, such as a screw driver, against the protection.

As an alternative the protection may be fixed to the frame in a breakable fashion.

In the square central opening 7 of the elastic body 2 a sealing unit (not shown) is normally received, which sealing unit is to receive one or more cables, pipes or the like. The sealing unit has the form of an elastic part, which is pressed against the cables or the like by means of the compression unit formed in the frame 1.

When the cable(s), pipe(s) or the like have been received in the sealing unit placed in the central opening 7 the fastening means are tightened in that the nuts 6 are rotated. As indicated above for insertion of the sealing units or the like the front fittings 3 may be pushed slightly to a side, by the function of the holes 11 formed as slots receiving the screws 5. By the tightening of the fastening means the elastic body 2 will be compressed in the axial direction, which means that it will expand in the radial direction. The expansion in radial direction will tighten the seal around the cable(s), pipe(s) or the like. Thus, the elastic body 2 could be said to form a compression unit, in the sense that the function of the elastic body is to compress the sealing.

The central opening 7 of the frame 1 may receive single pipes, cables etc. without any further sealing parts. If e.g. the central opening is circular it may be used for receiving just one cable or pipe.

In function the frame 1 is normally attached to a wall, floor, roof, top or bottom of a house, a cabinet, a ship etc. In the embodiment of FIGS. 1 and 2 the attachment is normally accomplished only by the radial expansion of the elastic body 2, when it is compressed axially by the fastening means 5, 6.

A person skilled in the art realises that the frame may have many different general forms, such as rectangular, square, oval, polygonal etc. Furthermore, the central opening may have other forms such as circular, rectangular, oval, polygonal.

In use the frame 1 is normally first placed in a suitably prepared opening. As stated above it is often only possible to work from one side of the frame 1. The frame 1 is placed in the opening with the front fittings 3 resting against the material surrounding the opening. The frame 1 is usually fixed to the wall or the like in which it is placed. The frame 1 may e.g. be placed in a container at assembly before the container is shipped to its final destination. Eventually the cables or the like normally are placed in a sealing unit having elastic bodies. Before the sealing units containing the cables or the like are received in the frame the net 8, closed protection 9 or any other protection is broken by means of a suitable tool being pressed against the protection. Finally, the compression unit in form of the elastic body 2 is activated in that the fastening means in form of screws 5 and nuts 6 are tightened to give a tight seal.

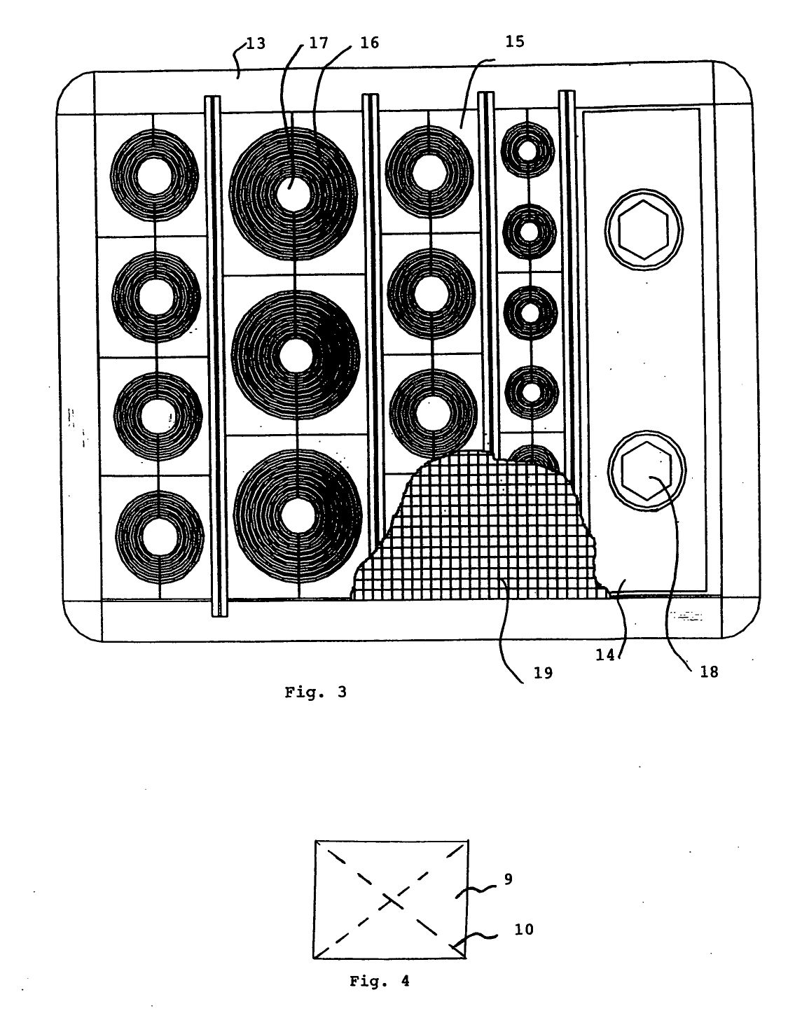

In the embodiment of FIG. 3 a further example of a frame 13 having a protection according to the present invention is shown. The frame 13 is a rigid outer frame forming a central rectangular opening. In the opening several rows of modules or sealing units 15 for receiving cables, pipe or the like are received. At one end of the opening of the frame 13 a compression unit 14 is received. The compression unit 14 is sometimes referred to as a wedge.

In the shown example the modules or sealing units 15 are formed of two halves between which a number of peeling sheets 16 and a centre part 17 are received. When a cable or pipe is to be received in a module 15 the centre part 17 and an appropriate number of peeling sheets 16 are removed. The number of peeling sheets 16 removed is related to the diameter of the cable pipe or the like to be received. A person skilled in the art realises that any number of modules 15 in any number of rows may be received inside the frame 13. However, as the modules 15 as such form no part of the present invention they will not be discussed further here.

The compression unit 14 is of an elastic material and receives compression screws 18. When the compression screws 18 are tightened the elastic material of the compression unit 14 will be compressed in the axial direction of the compression screws 18. The compression in the axial direction of the screws 18 leads to an expansion in other directions. However, as the compression unit 14 is restricted on three sides by the rigid frame 13 the expansion will be mainly in the direction towards the rows of modules 15 in the frame 13. The modules 15 are also made of an elastic material and will be pressed against any cable, pipe or the like received in the module 15. Thus, the modules 15 form sealing units in that they will seal against cables, pipes or the like received in the centre of the modules 15.

The frame 13 of FIG. 3 is furnished with a protection in form of a net 19. As stated above in connection with the embodiment of FIGS. 1 and 2 the net 19 may be replaced with other types of protections, being closed or having one or more openings. The protection may be made of a plastic, rubber or metallic material.

When a cable, pipe or the like is to be received in the frame 13, the compression screws 18 are loosened in order to be able to take out one module 15. Thereafter an opening is made in the net 19 and the cable, pipe or the like is pushed through said opening. The module 15 is then fitted around the cable, pipe or the like, in that the centre part 17 and an appropriate number of peeling sheets 16 are removed. Finally the compression screws 18 are tightened to seal around the cables, pipes or the like received in the frame 13.

1-10. (cancelled).

11. A frame for a cable entry, pipe penetration or the like comprising:
at least one compression unit comprising an elastic body, whereby the frame includes an opening for receiving one or more cables, pipes or the like with or without sealing units surrounding the cables, pipes or the like wherein a breakable protection is arranged in connection to the opening of the frame, to close off said opening.

12. The frame of claim 11, wherein the breakable protection is a net.

13. The frame of claim 11, wherein the protection is closed and/or the protection has indications of fracture.

14. The frame of claim 11, wherein the breakable protection is fixed to the frame by means of fastening means.

15. The frame of claim 14, wherein the protection is fixed to the frame in a breakable fashion.

16. The frame of claim 11, wherein the breakable protection is an integrated part of the frame.

17. The frame of claim 11, wherein the breakable protection is made of plastic, rubber, metal and/or the like.

18. The frame of claim 11, wherein said opening is arranged in the center of the elastic body and/or the opening is square in cross section.

19. The frame of claim 18, wherein the elastic has a cylindrical outer form; end plates are arranged at each end of the elastic body; the end plates are fixed to each other by means of fastening means going through the elastic body; the fastening means fixating the end plates to each other are screws and nuts; and each end plate comprises at least two equal parts.

20. The frame of claim 11, wherein the frame has a central rectangular opening adapted to receive a compression unit and one or more sealing units for receiving the one or more cables, pipes or the like.
